(19) United States
(12) Patent Application Publication
(10) Pub. No.: US 2014/0007818 A1
(43) Pub. Date: Jan. 9, 2014

(54) PET LEASH

(71) Applicant: Yao-Huang CHENG, New Taipei City (TW)

(72) Inventor: Yao-Huang CHENG, New Taipei City (TW)

(21) Appl. No.: 13/544,648

(22) Filed: Jul. 9, 2012

(51) Int. Cl. A01K 27/00

(52) U.S. Cl. 119/792; 119/795

(57) ABSTRACT

A pet leash includes a first strap and a second strap connected to the first strap. The first strap has a first elastic section, a first extending section disposed at each of two ends of the first elastic section, and a first snap-engagement unit coupled to the first extending section. The second strap has two second extending sections connected to the first snap-engagement unit and second snap-engagement units coupled to the second extending sections, respectively. The second snap-engagement units are put around the pet. The first snap-engagement unit at the end of the first strap is fixed to a selected point.

### FIELD OF THE INVENTION

The present invention relates to pet leashes, and more particularly, to a pet leash for restricting a pet's movement to a predetermined space, preventing the pet from performing abrupt movement and pulling the pet leash, thereby protecting the pet and its owner against injury efficiently.

### BACKGROUND OF THE INVENTION

In general, pet owners usually tie their pets up with pet leashes in order to avoid confining the pets to cages on a long-term basis or prevent the pets from moving freely to go astray or escape. To maximize the pets' range of movement, it is feasible to allow the pets to move freely for a maximum distance equal to the length of the leashes. In particular, pet birds, such as parrots, mynas, and thrushes, each have one of their legs tied to one end of a bird leash, whereas the other end of the bird leash is fastened to a selected point of a perch. Therefore, the pet birds can move freely along the perch and thereby move within a large movement space, but cannot escape.

The way of fastening a leg of a pet bird with a conventional bird leash requires providing a metal ring at one end of a bird leash and disposing the ring around the leg of the pet bird, thereby putting the pet bird on the leash. However, neither the metal ring disposed at one end of the conventional bird leash nor the length of the leash is adjustable, extendible, and elastic. If a pet bird is scared and flies aimlessly, the counteraction of the bird leash will cause injury to the pet bird readily. As regards the leash, it is typically made of a fabric or a plastic. Therefore, not only is the structural strength of the leash low, but the leash is likely to be torn (or severed) when bitten by the pet birds. However, if the leash comes in the form of a metallic chain, it will be likely to injure the pet bird. Accordingly, it is imperative to devise a pet leash that manifests enhanced practicability and safety.

### SUMMARY OF THE INVENTION

In view of the aforesaid drawbacks of the prior art, the inventor of the present invention conceived room for improvement in the prior art and thus conducted extensive researches and experiments according to the inventor's years of experience in the related industry, and finally developed a pet leash as disclosed in the present invention to manifest high structural strength as well as enhanced practicability and safety.

It is an objective of the present invention to provide a pet leash worn by a pet for restraining and guiding the pet to move within a predetermined space, wherein the elasticity of the pet leash prevents the pet from moving abruptly and pulling the pet leash, thereby protecting the pet and its owner against injury efficiently. Also, the aforesaid structures of the pet leash are conducive to the enhancement of the structural strength, practicability, and safety of the pet leash.

In order to achieve the above and other objectives, the present invention provides a pet leash. In a preferred embodiment, the pet leash comprises: a first strap comprising a first elastic section, a first extending section disposed at each of two ends of the first elastic section, and a first snap-engagement unit coupled to the first extending section; and a second strap comprising two second extending sections connected to the first snap-engagement unit and second snap-engagement units coupled to the second extending sections, respectively.

In the preferred embodiment of the pet leash, the first strap comprises a metal cord and a plastic layer enclosing the metal cord.

In the preferred embodiment of the pet leash, a first coupling portion is disposed at an end of the first extending section and coupled to the first snap-engagement unit.

In the preferred embodiment of the pet leash, the first snap-engagement unit comprises a hook coupled to an end of the first extending section.

In the preferred embodiment of the pet leash, the second strap comprises a metal cord and a plastic layer enclosing the metal cord.

In the preferred embodiment of the pet leash, the two second extending sections are formed by bending the second strap at the midpoint thereof.

In the preferred embodiment of the pet leash, a second coupling portion is disposed at a symmetric bend of the second strap and coupled to a first connecting portion coupled to the first snap-engagement unit.

In the preferred embodiment of the pet leash, a third coupling portion is disposed at an end of each of the two second extending sections and coupled to the second snap-engagement unit.

In the preferred embodiment of the pet leash, the second snap-engagement unit comprises a second connecting portion coupled to an end of the second extending section, a hook coupled to the second connecting portion, a third connecting portion coupled to the hook, and a ring coupled to the third connecting portion.

Accordingly, the present invention provides a pet leash. Second snap-engagement units of a second strap of the pet leash are disposed around the legs of a bird pet, respectively. A first snap-engagement unit disposed at the other end of a first strap of the pet leash is fixed to a perch. Therefore, not only is the bird pet's movement space maximized, but the bird pet is also prevented from going astray or escaping. Furthermore, a first elastic section of the first strap of the pet leash lessens the counteraction arising from an abrupt pull or stretch, thereby protecting the bird pet's legs and the pet owner. Also, the first and second straps each comprise a metal cord and a plastic layer enclosing the metal cord to thereby enhance the mechanical strength of the first and second straps, prevent the first and second straps from being bitten by the pets, and prevent the pets from being injured.

### BRIEF DESCRIPTION OF THE DRAWINGS

Objectives, features, and advantages of the present invention are hereunder illustrated with specific embodiments in conjunction with the accompanying drawings, in which:

FIG. 1 is a schematic perspective view of a pet leash according to a preferred embodiment of the present invention; and

FIG. 2 is a schematic view of application of the pet leash according to a preferred embodiment of the present invention.

### DETAILED DESCRIPTION OF THE PREFERRED EMBODIMENTS

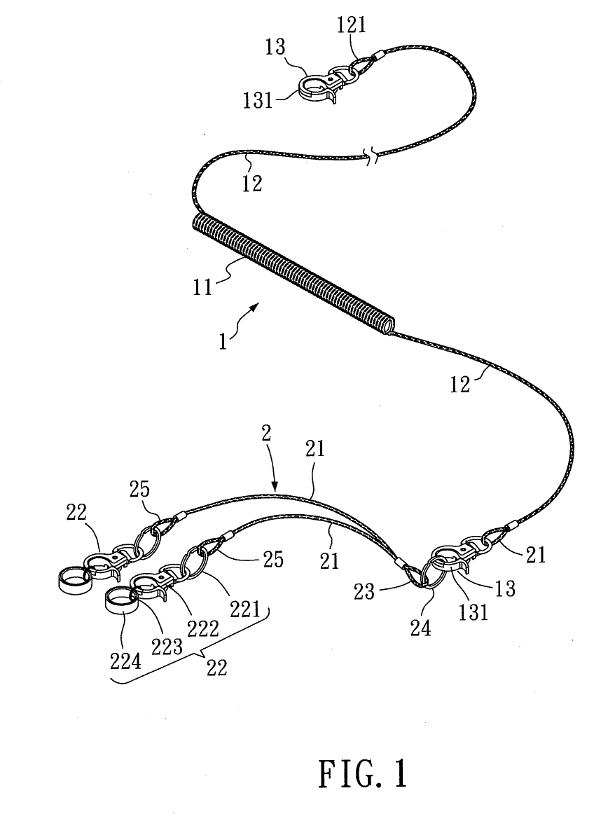

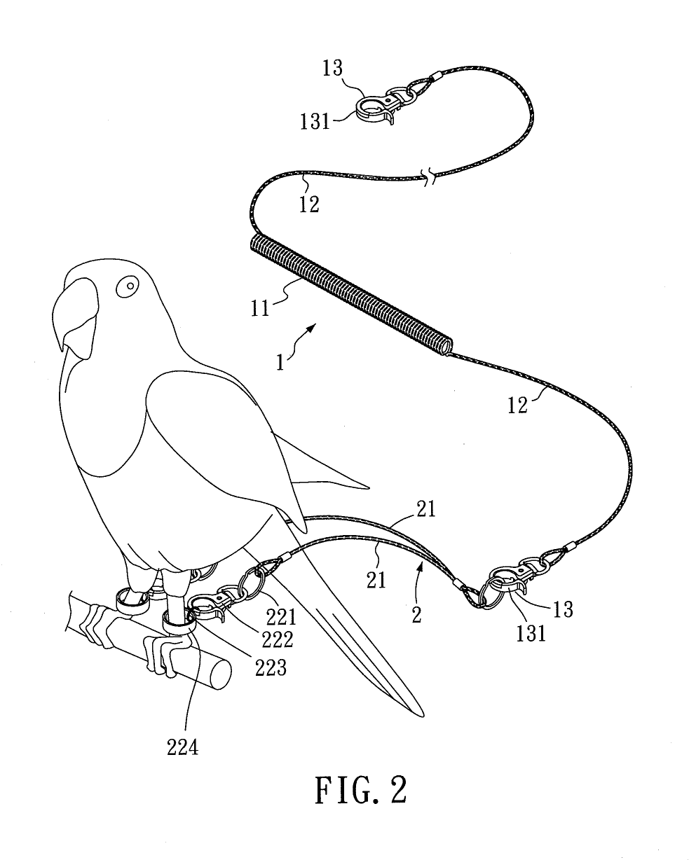

Referring to FIG. 1 and FIG. 2, there are shown a schematic perspective view and a schematic view of application of a pet leash according to a preferred embodiment of the present invention, respectively. As shown in the diagrams, in a preferred embodiment of the present invention, the pet leash comprises a first strap 1 and a second strap 2. The first strap 1 comprises a first elastic section 11 of a spiral shape or any other shapes, a first extending section 12 disposed at each of the two ends of the first elastic section 11, and a first snap-engagement unit 13 disposed at the end of each of the first extending sections 12. The second strap 2 comprises two second extending sections 21 connected to the first snap-engagement unit 13 and second snap-engagement units 22 coupled to the ends of the second extending sections 21, respectively.

In doing so, the pet leash of the present invention is assembled. Referring to FIG. 2, the operation of the pet leash requires: putting the second snap-engagement units 22 of the second strap 2 around a bird pet's legs, respectively; and fixing the first snap-engagement unit 13 at the other end of the first strap 1 to the perch to thereby maximize the bird pet's movement space, prevent the bird pet from going astray or escaping, and use the first elastic section 11 to lessen the counteraction arising from an abrupt pull or stretch, thereby protecting the bird pet's legs.

Referring to FIG. 1, in a preferred embodiment of the present invention, the first strap 1 comprises a metal cord and a plastic layer enclosing the metal cord so as to be of high mechanical strength and render the metal cord thin. Furthermore, the plastic layer protects a pet and prevents the metal cord from being bitten and severed by the pet. Also, one end of the first extending section 12 of the present invention can be bent to form a first coupling portion 121. The first snap-engagement units 13 are coupled to the first coupling portions 121, respectively. The first snap-engagement unit 13 comprises a hook 131 coupled to the first coupling portion 121 formed at one end of the first extending section 12.

Referring to FIG. 1, in a preferred embodiment of the present invention, the second strap 2 comprises a metal cord and a plastic layer enclosing the metal cord. The second strap 2 bends at the midpoint thereof symmetrically to form the two second extending sections 21. The second strap 2 forms at the symmetric bend thereof a second coupling portion 23. The second coupling portion 23 is coupled to the first snap-engagement unit 13 (the hook 131). Alternatively, as shown in the diagram, it is feasible for the second coupling portion 23 to be coupled to a first connecting portion 24, such that the second coupling portion 23 is coupled to the first snap-engagement unit 13 via the first connecting portion 24.

Each of the ends of the two second extending sections 21 of the present invention bends to form a third coupling portion 25, such that the second snap-engagement units 22 are coupled to the third coupling portions 25, respectively. Preferably, the second snap-engagement unit 22 comprises: a second connecting portion 221 coupled to the third coupling portion 25 at one end of the second extending section 21; a hook 222 coupled to the second connecting portion 221; a third connecting portion 223 coupled to the hook 222; and a ring 224 coupled to the third connecting portion 223. Therefore, the rings 224 can be put around the bird pet's legs, respectively, whereas the hook 222 facilitates the engagement and disengagement of the third connecting portion 223 and the ring 224.

Accordingly, the present invention meets the three requirements of patentability, namely novelty, non-obviousness, and industrial applicability. Regarding novelty and non-obviousness, the present invention discloses that a pet wears a pet leash for restraining and guiding the pet to move within a predetermined space, wherein the elasticity of the pet leash prevents the pet from moving abruptly and pulling the pet leash, thereby protecting the pet and its owner against injury efficiently. Also, the aforesaid structures of the pet leash are conducive to the enhancement of the structural strength, practicability, and safety of the pet leash. Regarding industrial applicability, products derived from the present invention meet market demands fully.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A pet leash, comprising:
a first strap comprising a first elastic section, a first extending section disposed at each of two ends of the first elastic section, and a first snap-engagement unit coupled to the first extending section; and
a second strap comprising two second extending sections connected to the first snap-engagement unit and second snap-engagement units coupled to the second extending sections, respectively.

2. The pet leash of claim 1, wherein the first strap comprises a metal cord and a plastic layer enclosing the metal cord.

3. The pet leash of claim 2, wherein a first coupling portion is disposed at an end of the first extending section and coupled to the first snap-engagement unit.

4. The pet leash of claim 1, wherein the first snap-engagement unit comprises a hook coupled to an end of the first extending section.

5. The pet leash of claim 3, wherein the first snap-engagement unit comprises a hook coupled to an end of the first extending section.

6. The pet leash of claim 1, wherein the second strap comprises a metal cord and a plastic layer enclosing the metal cord.

7. The pet leash of claim 6, wherein the two second extending sections are formed symmetrically by bending the second strap at a midpoint thereof.

8. The pet leash of claim 7, wherein a second coupling portion is disposed at a symmetric bend of the second strap and coupled to a first connecting portion coupled to the first snap-engagement unit.

9. The pet leash of claim 6, wherein a third coupling portion is disposed at an end of each of the two second extending sections and coupled to the second snap-engagement unit.

10. The pet leash of claim 1, wherein the second snap-engagement unit comprises a second connecting portion coupled to an end of the second extending section, a hook coupled to the second connecting portion, a third connecting portion coupled to the hook, and a ring coupled to the third connecting portion.

11. The pet leash of claim 9, wherein the second snap-engagement unit comprises a second connecting portion coupled to an end of the second extending section, a hook coupled to the second connecting portion, a third connecting portion coupled to the hook, and a ring coupled to the third connecting portion.
